(19) United States
(12) Patent Application Publication
(10) Pub. No.: US 2008/0031625 A1
(43) Pub. Date: Feb. 7, 2008

(54) WDM hybrid splitter module

(76) Inventors: Ryousuke Okuda, Kasugai City (JP); Noboru Uehara, Kasugai City (JP); Naoyuki Mekada, Kasugai City (JP); Taihei Miyakoshi, Kasugai City (JP)

Correspondence Address: SMITH PATENT OFFICE, 1901 PENNSYLVANIA AVENUE N W, SUITE 901, WASHINGTON, DC, 20006, US

(21) Appl. No.: 11/878,802

(22) Filed: Jul. 26, 2007

Related U.S. Application Data
(60) Provisional application No. 60/833,782, filed on Jul. 28, 2006.

(51) Int. Cl. H04J 14/00

(52) U.S. Cl. 398/71

(57) ABSTRACT

A downlink signal and WDM-PON signal from an OLT 1 are separated by an optical filter part 11, and a downlink signal is split by a power splitter part 12. A WDM-PON signal is also split in each wavelength by a demultiplexer part 13, and a downlink signal and a WDM-PON signal of either one of the wavelengths are outputted to each ONU, in an optical filter part 14. Moreover, an uplink signal from the ONU is introduced to the power splitter part 12 via the optical filter part 14, and outputted to the OLT 1 via the optical filter part 11. Therefore, it is possible to realize a hybrid splitter module which allows upgrading a downlink signal to a WDM-PON without adding changes to a device on a subscriber side.

### CROSS REFERENCE TO RELATED APPLICATION

This application is a nonprovisional application of U.S. Provisional Patent Application No. 60/833,782 filed on Jul. 28, 2006, currently pending. The disclosure of U.S. Provisional Patent Application No. 60/833,782 is hereby incorporated by reference.

### 1. FIELD OF THE INVENTION

The present invention relates to a WDM hybrid splitter module used in a communication system.

### 2. DISCUSSION OF THE RELATED ART

A PON (Passive Optical Network) is one of optical subscriber network construction systems, being a system for distributing light so that an OLT (Optical Line Terminal) which is a transceiver on a station side can connect to a plurality of ONUs (Optical Network Units) on a user side. Since a signal transmitted from a base station by an optical fiber is divided by a splitter module in a PON system as described above, cable costs can be reduced in comparison with a system for providing an optical fiber from an OLT to each ONU one by one. There is a demand to expand an optical transmission bandwidth which can be used on a terminal side in an optical communication system. In order to realize bandwidth expansion as described above, a Wavelength Division Multiplexing system (WDM) is employed. However, in a case of simply replacing an existing PON communication system with the WDM, a huge investment is required because not only a splitter for link-up portion but also a terminal system of each ONU have to be changed.

Meanwhile, Kazutaka Nara et al. “Monolithically Integrated Wideband Optical Splitter/Router on Silica-based Planar Lightwave Circuit” ECOC 2004 Proceedings Vol. 2 Paper Tu1.4.2 PP140-141 discloses a splitter in a hybrid configuration of a G-PON and WDM-PON which has eight channels with a band of 1.65 μm (1 ch bandwidth is 2.8 nm). This device is realized by a WDM filter of an MZI (Mach-Zehnder Interferometer) type using a silica-based planar lightwave circuit (PLC) technique, an array waveguide grating element (simply referred to as an AWG hereinafter), and an optical splitter.

This conventional splitter module is not realized without changing an ONU. There is a problem that an inexpensive system cannot be constructed because it is impossible to use a DFB (Distribution Feedback type) laser which does not require temperature adjustments in a WDM signal transmitter on an OLT side if a 1 ch bandwidth (1 dB width) of a WDM signal is 2.8 nm. Furthermore, the above-described configuration has a G-PON insertion losses of 13.9 db (1.31 μm), 12.9 dB (1.49 μm), and 12.9 dB (1.55 μm), which is about twice (3 dB) as large as an insertion loss of a current G-PON of 8 ch. For this reason, there has been a problem that a communication distance is halved and replacement of a current system is difficult.

### SUMMARY OF THE INVENTION

An object of the present invention is to realize a hybrid splitter module which is capable of improving a communication speed at low costs and low loss by upgrading a downlink signal to a WDM-PON and combining with a conventional device without adding any changes to a device on a subscriber side in a PON system.

To solve the problems, a WDM hybrid splitter module in an optical communication system connected between a station-side transceiver for transmitting and receiving an optical signal of a PON signal bandwidth and for transmitting an optical signal of a WDM-PON wavelength bandwidth configured with a plurality of wavelength bandwidths, and a user-end transceiver, comprises: a first filter part connected to said station-side transceiver for separating a PON signal wavelength band from a WDM-PON signal wavelength band; a splitter part for splitting an optical signal of a PON signal wavelength band separated by said first optical filter part into 1:n, and for coupling optical signals of an uplink PON signal wavelength band obtained from the user-end transceiver; a demultiplexer part for splitting said WDM-PON signal wavelength band separated by said first optical filter part into each channel in accordance with a wavelength; and a second optical filter part composed of a group of filters for coupling signals of the PON signal wavelength band split by said splitter part and either one of the WDM-PON signal wavelength bands separated by said demultiplexer part and outputting it to the user-end transceiver, and for outputting a signal of an uplink PON signal wavelength band outputted from the user-end transceiver to said splitter part.

Said first optical filter part may be a filter composed of dielectric multilayered films.

Said second optical filter part may be a filter composed of dielectric multilayered films.

Said demultiplexer part may be a filter composed of dielectric multilayered films.

Said demultiplexer part and second optical filter part may be configured by including a plurality of WDM modules integrated with one input, one output, and two input-outputs provided for each wavelength band of a WDM-PON signal.

Said demultiplexer part may be composed of an array waveguide grating element.

An integrated composite WDM module with one input and 2n input-outputs (n is a natural number) may constitute said demultiplexer part and second optical filter part.

Said WDM-PON signal wavelength band may be in a bandwidth of larger than or equal to 1200 nm on a short wavelength side thereof and smaller than or equal to 1700 nm on a long wavelength side.

Said WDM hybrid splitter module may be adapted to transmission systems for a G-PON (Gigabit-Passive Optical Network), B-PON (Broadband-Passive Optical Network), GE-PON (Gigabit Ethernet-Passive Optical Network), and E-PON (Ethernet-Passive Optical Network).

According to the present invention with these features, a shift from a PON optical access transmission system to a WDM-PON system is allowed by changing a splitter without changing devices of an ONU in order to upgrade a transmission capacity. Therefore, an equipment investment to an ONU is not required, and an effect that allows upgrading to a next-generation optical network or a combination use therewith can be easily achieved. Since the number of ONUs is extremely large, it has considerable merits to require no changes in the ONU, so that a communication system of a PON system and a communication system of a WDM-PON system can be switched or used in combination at low equipment costs.

### BRIEF DESCRIPTION OF DRAWINGS

FIG. 1 is a diagram showing an optical communication system and a WDM hybrid splitter module thereof according to embodiment 1 of the present invention;

FIG. 2 is a spectral diagram of a wavelength according to embodiment 1;

FIG. 3 is a diagram showing a WDM hybrid splitter module according to embodiment 2 of the present invention;

FIG. 4A is a spectral diagram showing an example of using light of the WDM hybrid splitter module according to embodiment 2;

FIG. 4B is a graph showing transmission characteristics of a first optical filter;

FIG. 4C is a diagram showing transmission characteristics of each filter of a demultiplexer part;

FIG. 5 is a diagram showing a WDM hybrid splitter module according to embodiment 3 of the present invention;

FIG. 6 is a diagram showing an example of a composite module used for embodiment 3;

FIG. 7A is a spectral diagram showing an example of using light of the WDM hybrid splitter module according to embodiment 3;

FIG. 7B is a graph showing transmission characteristics of a band pass filter;

FIG. 7C is a diagram showing transmission characteristics of a group filter;

FIG. 8 is a diagram showing another example of the composite module;

FIG. 9 is a diagram showing a WDM hybrid splitter module according to embodiment 4 of the present invention;

FIG. 10A is a spectral diagram showing an example of using light of the WDM hybrid splitter module according to embodiment 4;

FIG. 10B is a graph showing transmission characteristics of first and second optical filters;

FIG. 10C is a diagram showing transmission characteristics of an AWG;

FIG. 11 is a diagram showing a WDM hybrid splitter module according to embodiment 5 of the present invention;

FIG. 12 is a diagram showing a composite module of the WDM hybrid splitter module according to embodiment 5; and

FIG. 13 is a diagram showing another example of the composite module according to embodiment 5.

### DESCRIPTION OF THE PREFERRED EMBODIMENTS

### Embodiment 1

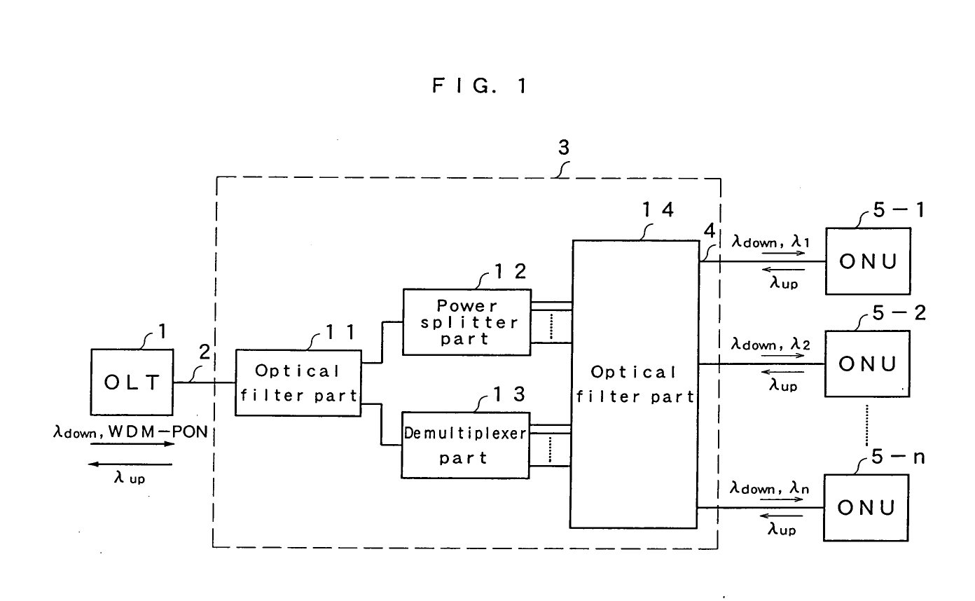

FIG. 1 is a configuration diagram showing a WDM hybrid splitter module according to embodiment 1 of the present invention. In FIG. 1, an OLT 1 is a transceiver of a station in an optical communication system, and connected to a WDM hybrid splitter module 3 via a single-mode optical fiber 2. The splitter module 3 is connected to a large number of ONUs 5-1 to 5-n of subscriber's devices via single-mode optical fibers 4. The OLT 1 transmits a downlink signal of a PON while receiving an uplink optical signal, and sends wavelength-multiplexed WDM-PON signals of λ1 to λn as a downlink signal. The ONUs 5-1 to 5-n receive a downlink signal in a PON wavelength bandwidth or a downlink signal in either one of the wavelengths of the WDM-PON signal to be obtained from the splitter module 3, and output a signal of an uplink wavelength bandwidth to a side of the splitter module 3.

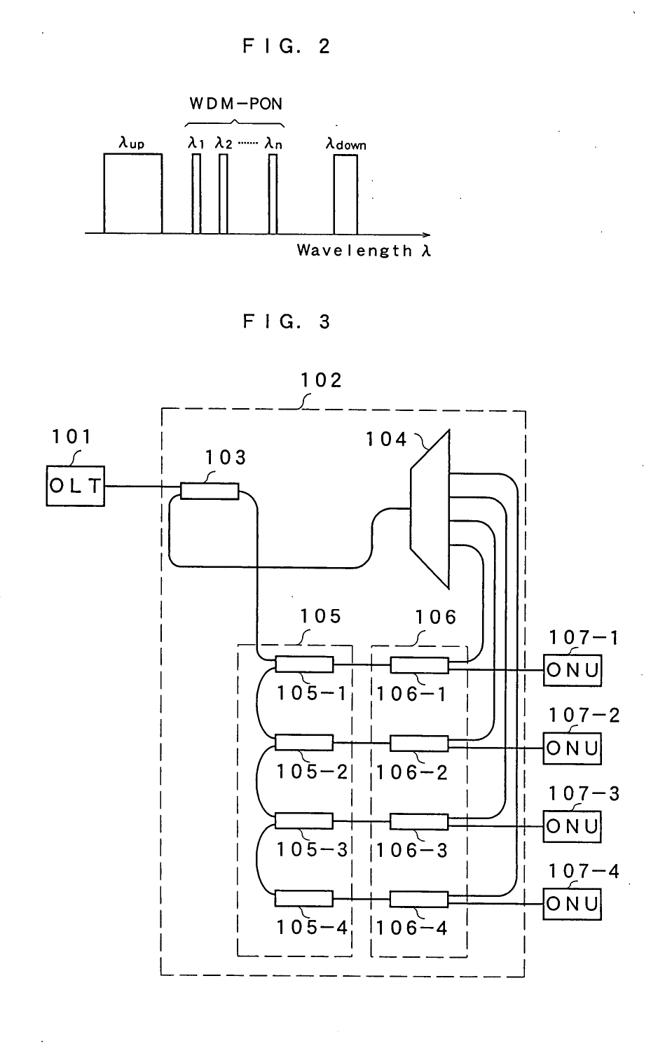

Explained next will be the WDM hybrid splitter module 3. The WDM hybrid splitter module 3 is configured by including a first optical filter part 11, power splitter part 12, demultiplexer part 13, and second optical filter part 14. The first optical filter part 11 separates light into a PON signal bandwidth (λ down, λ up) and a WDM-PON signal bandwidth (λ1 through λn) to be sent from the OLT 1 as shown in FIG. 2. A WDM signal here is arranged in an arbitrary wavelength bandwidth except for a PON signal bandwidth, in which an arbitrary wavelength can be selected within a range from 1200 nm in a short wavelength to 1700 nm in a long wavelength, for example. The power splitter part 12 splits light of a PON signal bandwidth which was split in the optical filter part 11 into 1/n. The demultiplexer part 13 demultiplexes a WDM-PON signal bandwidth in each of wavelengths λ1, λ2 . . . so as to generate an output of n pieces. The second optical filter part 14 outputs a signal of a PON signal bandwidth and a wavelength λi which is either one of the wavelengths split in the demultiplexer part 13, to each of the ONUs 5-i (i=1 to n), and transmits a signal in a bandwidth of a wavelength λup in an uplink direction which is outputted from the ONUs 5-i, to the power splitter part 12. The power splitter part 12 integrates these signals and returns them to the OLT 1 via the optical filter part 11. According to the present embodiment, a conventional module which only uses a power splitter part to connect the OLT and ONU is replaced by the WDM hybrid splitter module which is also capable of dealing with a WDM signal. Herewith, a subscriber device can transmit and receive a normal PON signal and receive a signal in a wavelength band of either one of WDM-PON signal bandwidths to be sent from the OLT.

Moreover, if a dielectric multilayered film filter is used for the first and second optical filter parts and the demultiplexer part, usage in an environmental temperature of −40° C. to 85° C. which is difficult for a conventional PLC-based optical filter can be possible, so that it is possible to use both indoors and outdoors, and an insertion loss can be suppressed. Accordingly, if the hybrid system of the present invention is introduced, a transmission distance similar to that of a conventional PON system can be realized. Furthermore, while a conventional device of MZI type has a problem of low versatility in designing a WDM-PON signal bandwidth and a channel number or the like, using the dielectric multilayered film filter provides an advantage that a signal bandwidth and a channel number can be arbitrarily selected. Then, if a signal bandwidth of each channel of a downlink WDM-PON is set to ±7.5 nm similar to a conventional CWDM, a DFB laser which does not require temperature adjustments can be used for a transmitter on an OLT side, so that it is possible to obtain an effect that a system configuration becomes inexpensive.

### Embodiment 2

Next, explained below will be a more detailed embodiment according to the present invention. Embodiment 2 exhibits a WDM hybrid splitter module using a WDM-PON signal of four channels in a band of 1370 to 1480 nm with an interval of 20 nm. In the present embodiment, the module is used by being replaced with a G-PON splitter module, in which a WDM-PON bandwidth having a broad downlink transmission bandwidth can be used on a user's demand.

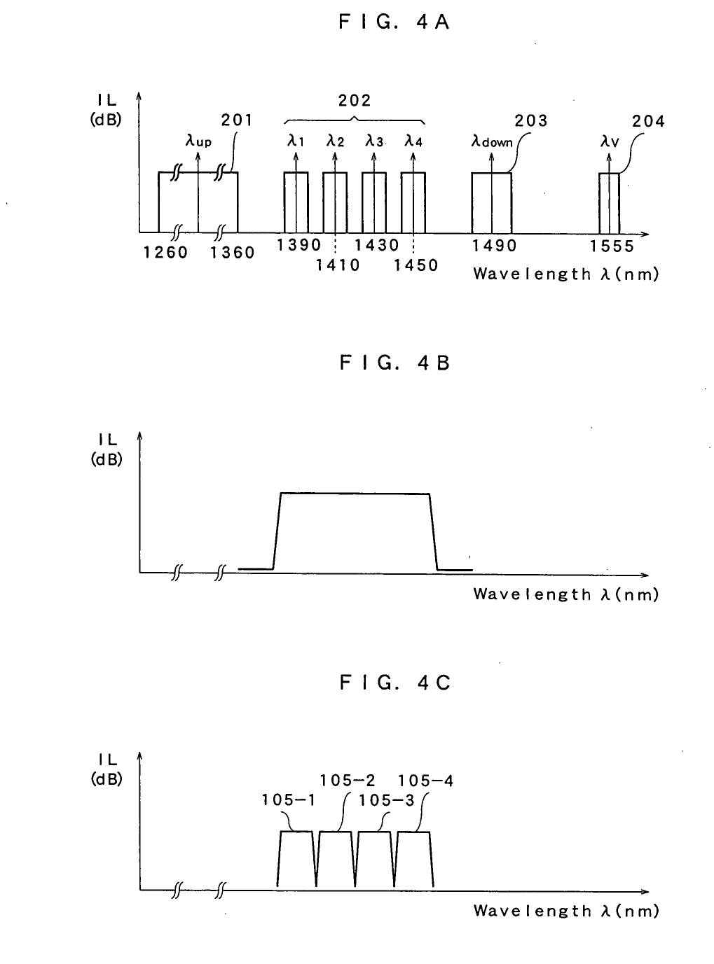

FIG. 3 is a configuration diagram of the WDM hybrid splitter module according to embodiment 2. In FIG. 3, an OLT 101 is connected to an input port of a WDM hybrid splitter module 102 by a single-mode optical fiber. A first optical filter part 103 is configured by a dielectric multilayered film filter with a total film thickness of 39.6 μm in which Ta2O5 having a refractive index of 2.09 and SiO2 having a refractive index of 1.48 are alternately laminated for a total of 127 layers, for example, on a glass substrate transparent in an infrared range. This filter is a band pass filter which passes a WDM signal bandwidth 202 of 1370 to 1480 nm. And, the filter reflects an uplink signal bandwidth 201 of 1260 to 1370 nm (λup), a downlink signal bandwidth 203 of 1480 to 1500 nm (λdown), and a video signal bandwidth 204 of 1550 to 1560 nm (λv), as shown in FIG. 4A. A reflection port of the optical filter part 103 is connected to a power splitter part 104. The power splitter part 104 is a power splitter which splits input light into four without making any changes, in which power is made to be ¼. An input port of a demultiplexer part 105 is also connected to a transmission port of the optical filter part 103 via a single-mode optical fiber. The demultiplexer part 105 includes a band pass filter (BPF) 150-1 to 150-4, each of which is composed of a dielectric multilayered film filter with a total film thickness of 48.7 μm in which Ta2O5 and SiO2 are alternately laminated for a total of 168 layers, for example, on a glass substrate transparent in an infrared range. The demultiplexer part 105 divides the WDM signal bandwidth of 1370 to 1480 nm into four of λ1 to λ4 in every 20 nm band (more specifically, in 1390 nm, 1410 nm, 1430 nm, and 1450 nm). That is, as indicated in a transmission ratio shown in FIG. 4C, the BPF 105-1 is a filter which passes light of the wavelength λ1 and reflects light of λ2 to λ4. The BPF 105-2 is a filter which passes light of λ2 and reflects light of λ3 and λ4. Moreover, the BPF 105-3 is a filter which passes light of λ3 and reflects light of λ4. The BPF 105-4 is a filter which passes light of λ4. Then, a group of output ports of this demultiplexer part 105 is connected to a group of input ports of an optical filter part 106, respectively.

The second optical filter part 106 includes four of group filters (GF) 106-1 to 106-4 composed of dielectric multilayered films. Each of these filters 106-1 to 106-4 is a filter which passes a signal light in a group of the wavelengths λ1, λ2, λ3 and λ4 while reflecting light of the other wavelength. These filters are assumed to be a group filter because the WDM-PON signals of the wavelengths λ1 to λ4 are entirely passed. A group of reflection ports of each group filter is connected to a group of output ports of the power splitter part 104, and a group of transmission ports of the each group filter is connected to a group of the ONUs, by single-mode optical fibers, respectively.

Explained next will be an operation. As shown in FIG. 4A, a band of 1.31 μm (λup) is used as a G-PON uplink signal 201, a band of 1.49 μm (λdown) is used as a downlink signal 203, a band of 1.55 μm (λv) is used as a downlink video signal 204, and 1370 to 1480 nm are used as the WDM-PON signal 202. In this case, the downlink signals 203 and 204 transmitted from the OLT 101 are initially reflected by a filter of the optical filter part 103, and enter the power splitter part 104 so as to be split into four. The downlink signal which was split into four is reflected by the respective group filters of the second optical filter part 106, and received by the each ONU 107. On the contrary, the uplink signal 201 transmitted from the ONU 107 is reflected by the respective filters of the second optical filter part 106, and enters the power splitter part 104 so as to be integrated into one signal in the single-mode optical fiber. It is then reflected by the optical filter part 103 and received by the OLT 101.

Next, in a case of using the uplink signal 201 and the downlink WDM-PON signal 202, a WDM-PON signal and the optical signals of λ1 to λ4 are sent from the OLT 101 toward ONUs 107-1 to 107-4, respectively. The downlink WDM signal 202 initially passes through the optical filter part 103 characterized as shown in FIG. 4B, and enters the demultiplexer part 105 so as to be split into four channels of λ1 to λ4 by the demultiplexer part 105. The downlink WDM signal 202 which was split into four passes through each of the filters of the optical filter part 106, and is received by the respective ONUs 107-1 to 107-4. An uplink signal transmitted from the respective ONU 107 is the same as described above.

Thus, it is not necessary to change a large number of ONUs which are terminals on a user side, so that a G-PON and WDM-PON can be switched and used in combination. Moreover, a usage temperature range of −40° C. to 85° C. is required in a case of using a branching module outdoors, however, the dielectric multilayered film filters are used in the first and second optical filters 103 and 106 and the demultiplexer part 105 in embodiment 2, so that an operational reliability within the usage temperature range can be satisfied. Furthermore, a downlink WDM signal is made to have an interval of 20 nm, a DFB laser without requiring temperature adjustments can be used in a transmitter on a station side, and further cost reduction can be realized. Other than the above-described configuration, a G-PON system and a WDM-PON system can be used in combination synchronously or asynchronously. Flexible utilization can be possible such as utilizing a PON band as a signal band common to each ONU, utilizing a WDM signal as a specific signal band, and using selectively at the time of disasters on emergency or for the purpose of a backup.

### Embodiment 3

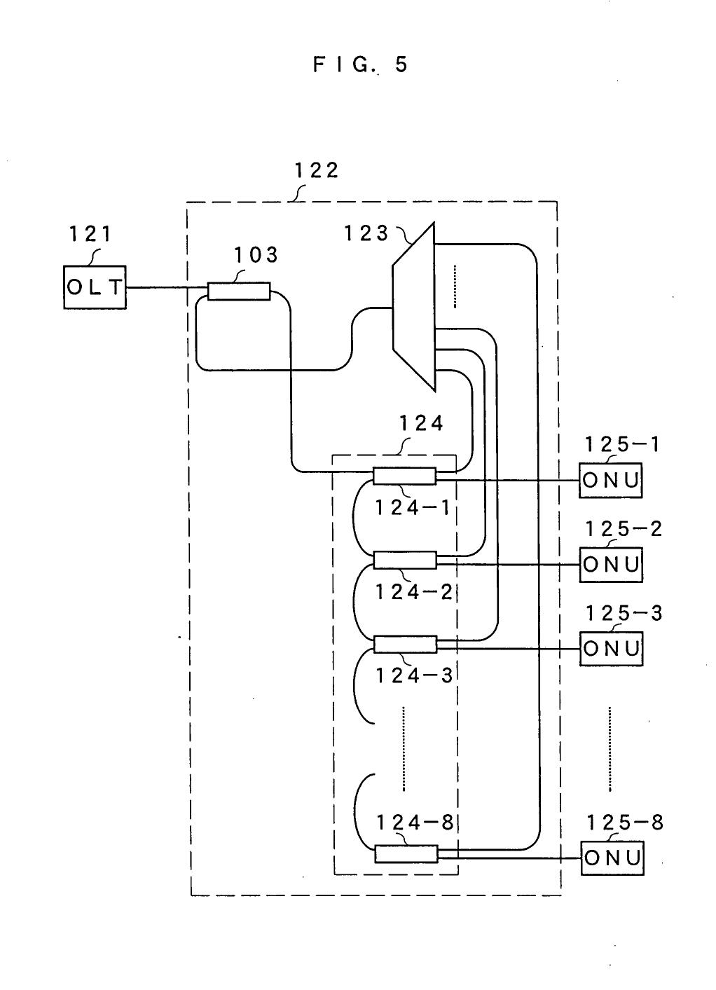

Embodiment 3 exhibits a WDM hybrid splitter module using a downlink signal of 8 ch in a band of 1370 to 1480 nm with an interval of 10 nm as the WDM signal 202. FIG. 5 shows a configuration diagram of the WDM hybrid splitter module according to embodiment 3. In embodiment 3, a WDM-PON signal having eight channels of λ1 to λ8 with an interval of 10 nm in a band of 1370 to 1480 nm is used. In embodiment 3, a signal from an OLT 121 is added to a first optical filter 103 of a WDM hybrid splitter module 122, and a signal in a PON bandwidth is separated and added to a power splitter part 123. The power splitter part 123 is a splitter which divides a downlink signal of an inputted signal bandwidth equally into eight, and each output thereof is inputted to each filter of a WDM module group 124. The WDM module group 124 is realized by integrating the above-described demultiplexer part and the second optical filter part, and composed of eight WDM modules 124-1 to 124-8 having one input, one output, and two input-outputs.

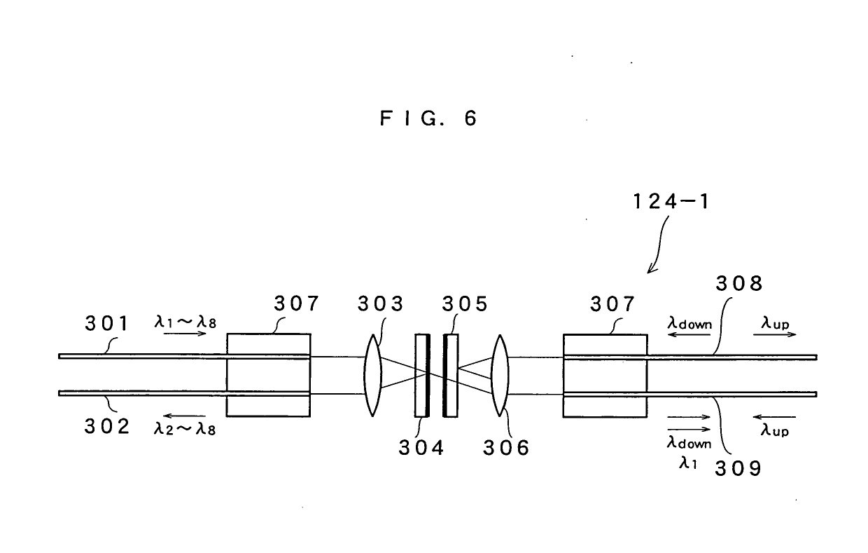

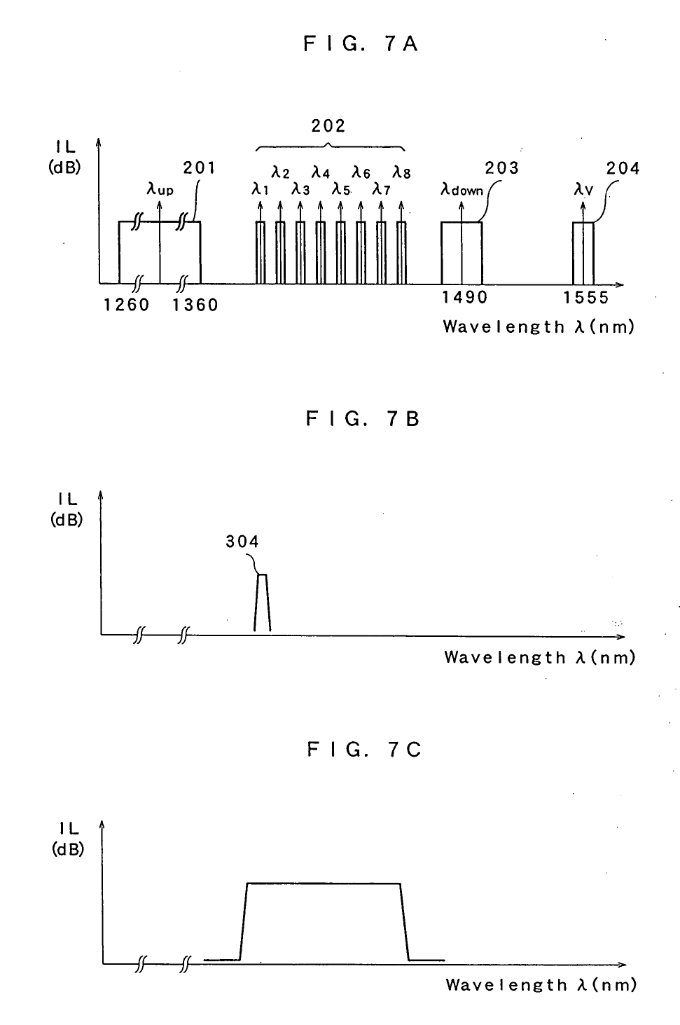

FIG. 6 shows a configuration of the WDM module 124-1 having one output, one output, and two input-outputs. Optical fibers 301 and 302 are held by an optical fiber holder 307. The optical fiber 301 is connected to the first optical filter part 103, and the optical fiber 302 is connected to the WDM module 124-2 in the subsequent stage. Light emitted from the optical fiber 301 is made incident to a band pass filter 304 via a lens 303. The lens 303 can be composed of either one of a GRIN lens, spherical lens, and aspherical lens. The band pass filter 304 is also composed of a dielectric multilayered film with a total film thickness of 23.9 μm in which Nb2O5 and SiO2 are alternately laminated for a total of 112 layers for example, on a transparent glass substrate in the infrared range. The band pass filter 304 passes light of the wavelength λ1 and reflects light of the other wavelengths as indicated in a transmittance ratio shown in FIG. 7B. A group filter 305 is also composed of a dielectric multilayered film with a total film thickness of 39.6 μm in which Ta2O5 and SiO2 are alternately laminated for a total of 127 layers for example, on the transparent glass substrate in the infrared range.

The group filter 305 passes light in a WDM-PON downlink signal bandwidth of the wavelengths λ1 to λ8, and reflects the others. A lens 306 and the optical fiber holder 307 are provided adjacent to the group filter 305. The lens 306 can be composed of either one of the GRIN lens, spherical lens and aspherical lens. The optical fiber holder 307 holds optical fibers 308 and 309. The optical fiber 308 is connected to the power splitter 123, and the optical fiber 309 is connected to each ONU or an ONU 125-1 in this case. The group filter 305 is capable of reflecting an uplink signal emitted from the optical fiber 309 to the optical fiber 308. The remaining WDM modules 124-2 to 124-8 are also similar to the WDM module 124-1 except for a point that the band pass filter 304 passes λ2 to λ8, respectively.

Explained next will be an operation. First, a band of 1.31 μm (λup) is used as the G-PON uplink signal 201, a band of 1.49 μm (λdown) is used as the downlink signal 203, a band of 1.55 μm (λv) is used as the downlink video signal 204, and 1370 to 1480 nm is used as the WDM-PON signal 202, as shown in FIG. 7A. In this case, the downlink signals 203 and 204 transmitted by the OLT 121 are initially reflected by a dielectric multilayered film filter of the first optical filter part 103, and split into eight by the power splitter part 123. The downlink signal which was split into eight is reflected by the respective group filters of the WDM module group 124, and received by the respective ONU 125. On the contrary, the uplink signal 201 transmitted from the ONU 125 is initially reflected by the respective group filters of the WDM module group 124, and enters the power splitter part 123 so as to be integrated into one single-mode optical fiber. It is then reflected by a dielectric multilayered film filter of the first optical filter part 103, and received by the OLT 121.

Next, in a case of using the uplink signal 201 and the downlink WDM-PON signal 202, optical signals of λ1 to λ8 are sent from the OLT 121 toward the ONUs 125-1 to 125-8 as a WDM-PON signal, respectively. The downlink WDM signal 202 initially passes through the optical filter part 103, being split into eight channels of λ1 to λ8 by each band pass filter of the WDM module group 124, and light with each wavelength passes through the group filter 305 so as to be received by the ONUs 125-1 to 125-8, respectively. An uplink signal transmitted from each ONU 125 is the same as described above.

As described above, the demultiplexer part and the second optical filter part are realized by the WDM module group with one input, one output, and two input-outputs, so as to be possible to suppress costs by about a half and reduce a volume ratio by maximum 50% for miniaturization. The demultiplexer part and the second optical filter part account for 80% of a total cost in embodiment 2, and the total cost can be reduced by about 40% according to embodiment 3. This configuration is extremely valuable for an access system optical communication industry which is exposed to fierce price competition. In a case of the above described configuration, an uplink signal, a downlink signal, and a downlink WDM signal are made to have insertion losses of −10.8 dB, −10.8 dB, and −3.6 dB, respectively by using the dielectric multilayered film filter. In a case of a conventional MZI type, an uplink signal, a downlink signal, and a downlink WDM signal are made to have insertion losses of, for example, −13.9 dB, −12.9 dB, and −8.0 dB, respectively. In the present invention, an approximately double distance of transmission, however, is achieved in an extremely low loss in comparison with those of the conventional MZI type. In other words, costs of constructing the system are halved.

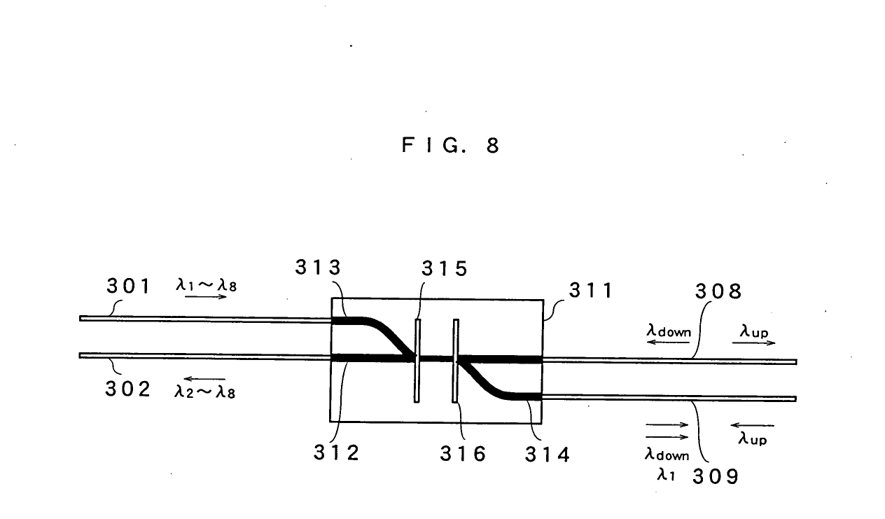

Next, shown in FIG. 8 is a modified example of the WDM modules 124-1 to 124-8. In this module, a PLC 312 is provided for a quartz base 311 so as to connect the optical fibers 302 and 308 as shown in the figure, in which an optical waveguide 313 extended from an end surface of the optical fiber 301 and an optical waveguide 314 from the optical fiber 309 are further connected to the waveguide 312 as shown in the figure. Arranged therebetween are a dielectric multilayered film filter 315 having the same characteristics as the above-described band pass filter 304 being laminated on the glass substrate or polyimide substrate and a band pass filter 316 having the same characteristics as the group filter 305. Thus, the WDM module can be configured by an optical waveguide technique.

### Embodiment 4

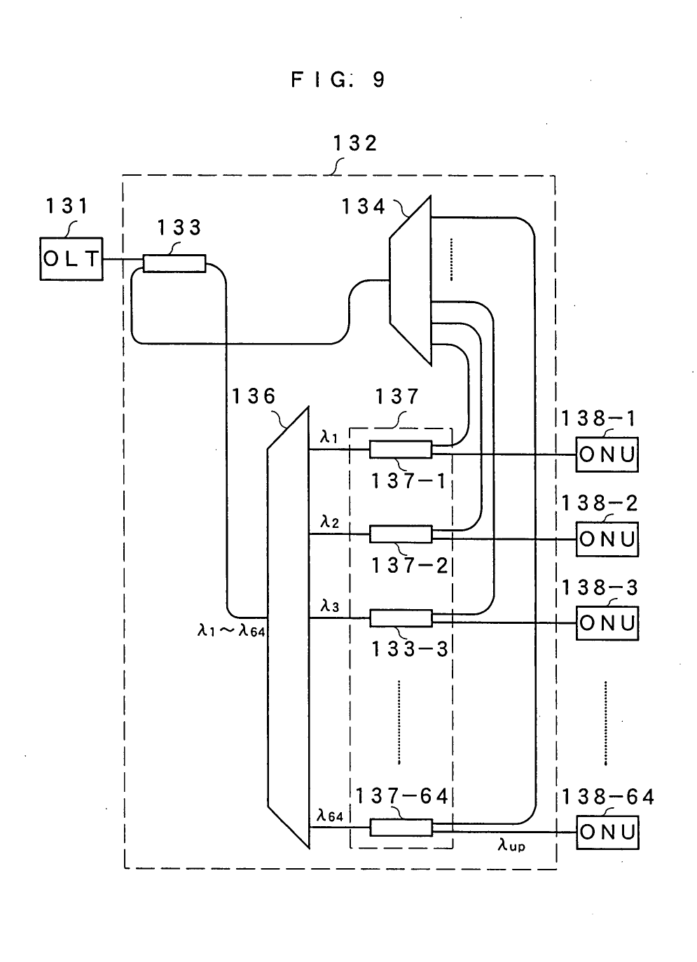

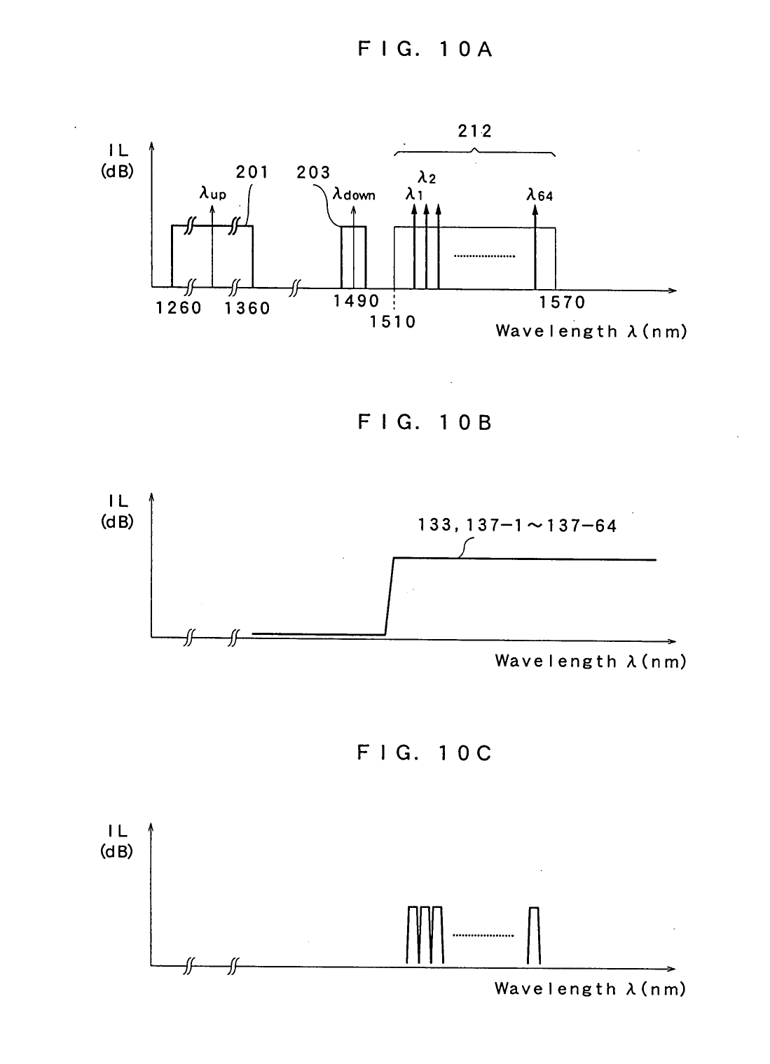

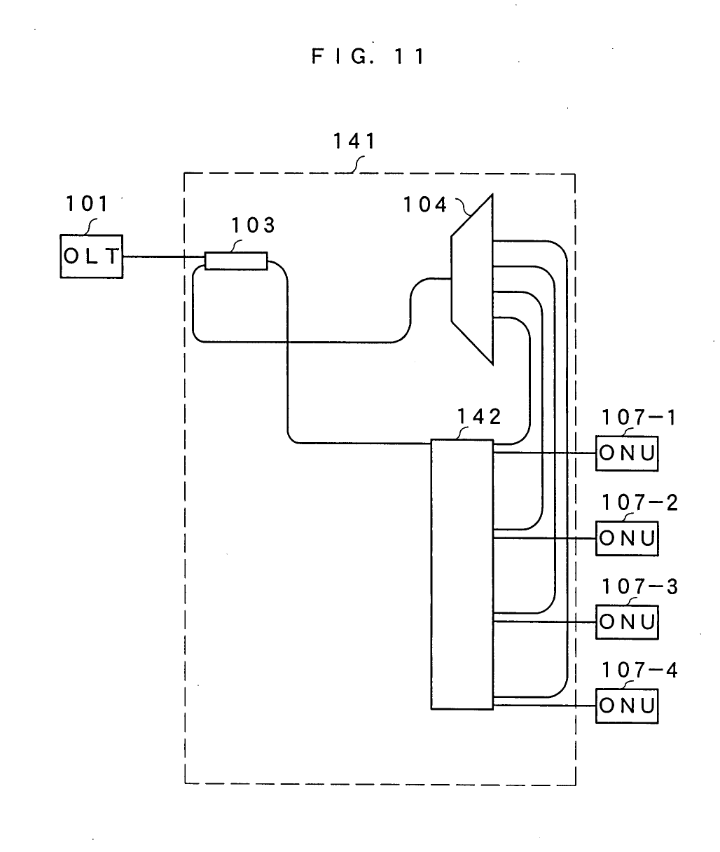

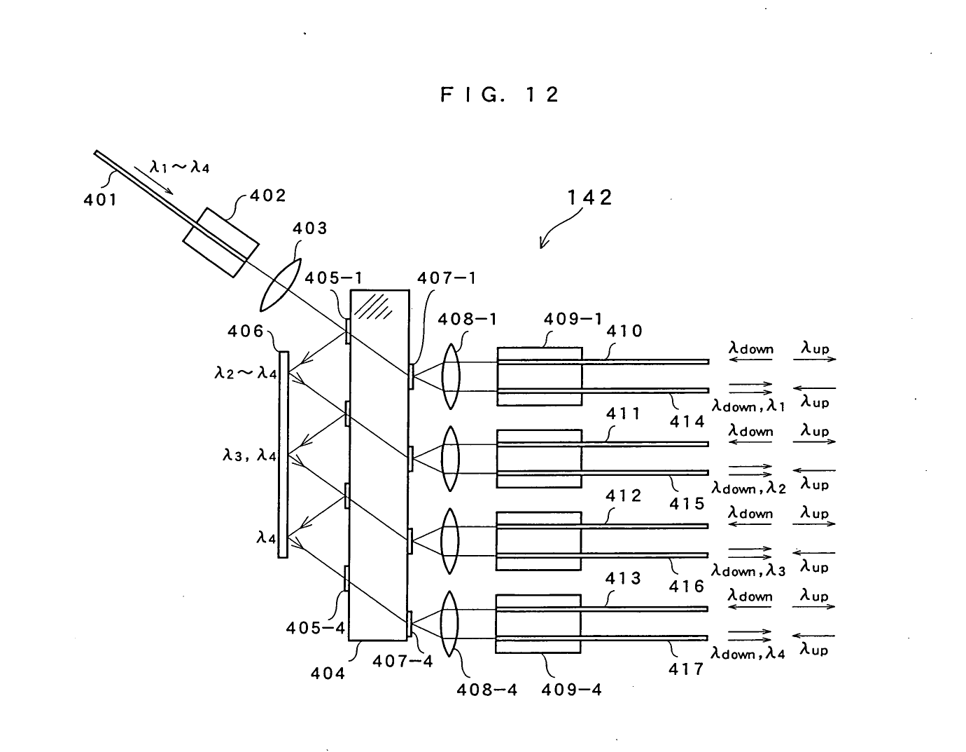

Embodiment 4 exhibits a WDM hybrid splitter module using a downlink signal of 64 ch in a band of 1510 to 1570 nm with an interval of 0.8 nm as the WDM signal 202. FIG. 9 shows a configuration diagram of the WDM hybrid splitter module according to embodiment 4. In embodiment 4, a WDM-PON signal 212 having 64 channels of λ1 to λ64 in a band of 1510 to 1570 nm with an interval of 0.8 nm is used as shown in FIG. 10A. In embodiment 4, a signal from an OLT 131 is added to a first optical filter part 133 in a WDM hybrid splitter module 132, and a PON signal bandwidth is added to a power splitter 134. The power splitter part 134 is a splitter which divides a downlink signal of an inputted signal bandwidth equally into 64, and each output thereof is inputted to respective filters 137-1 to 137-64 of a second filter part 137. Each of the filters in the first and second optical filter parts is configured by a dielectric multilayered film with a total film thickness of 23.2 μm in which a Ta2O5 layer and an SiO2 layer are alternately laminated for a total of 118 layers for example, on the transparent glass substrate in the infrared range. These filters are a high-pass filter which passes a WDM-PON signal as shown in FIG. 10B.

A WDM-PON signal which passed through the first optical filter part 133 is introduced into an AWG 136. The AWG 136 has a configuration of connecting a planar waveguide of a lens shape by an array with a different length, being a wavelength demultiplexing element which is capable of decomposing incident light into a fine wavelength. Here, the incident light is demultiplexed in each of the wavelengths λ1 to λ64 as indicated in its characteristics shown in FIG. 10C. An optical signal of each of the wavelengths that were thus demultiplexed is introduced into the respective filters 137-1 to 137-64 of the second filter part 137. The other configuration is the same as embodiment 2. Since an operation of the AWG is ensured from −5° C. to 60°C., usage thereof is limited to indoors, but there is an advantage that an insertion loss is not increased in proportion to the number of channels even if a channel of the WDM signal is increased. Accordingly, the number of WDM signal channels can be increased while maintaining a transmission distance, so that it can be possible to suppress a charge per user and increase a transmission rate.

Although the AWG of 64 channels is used in embodiment 4, the number of channels can be arbitrary, and a WDM-PON signal with a further large number of channels can be used.

### Embodiment 5

Embodiment 5 exhibits a WDM hybrid splitter module using a composite module in the demultiplexer part and the second optical filter part. FIG. 11 shows a configuration diagram of the WDM hybrid splitter module according to embodiment 5. In embodiment 5, the WDM hybrid splitter module 141 has the first optical filter part 103 connected to the OLT 101 and the power splitter part 104. Then, a composite module is used for the demultiplexer part and the second filter part. While cost reduction is realized in embodiment 3 by using a plurality of the WDM modules in which the demultiplexer part and the respective filters of the second optical filter part are integrated in each wavelength, further cost reduction is realized in embodiment 5 by compounding a plurality of the WDM modules into one composite module 142. A wavelength used for a G-PON and WDM-PON is similar to that of embodiment 2, so that an identical reference numeral is used to omit detailed explanation.

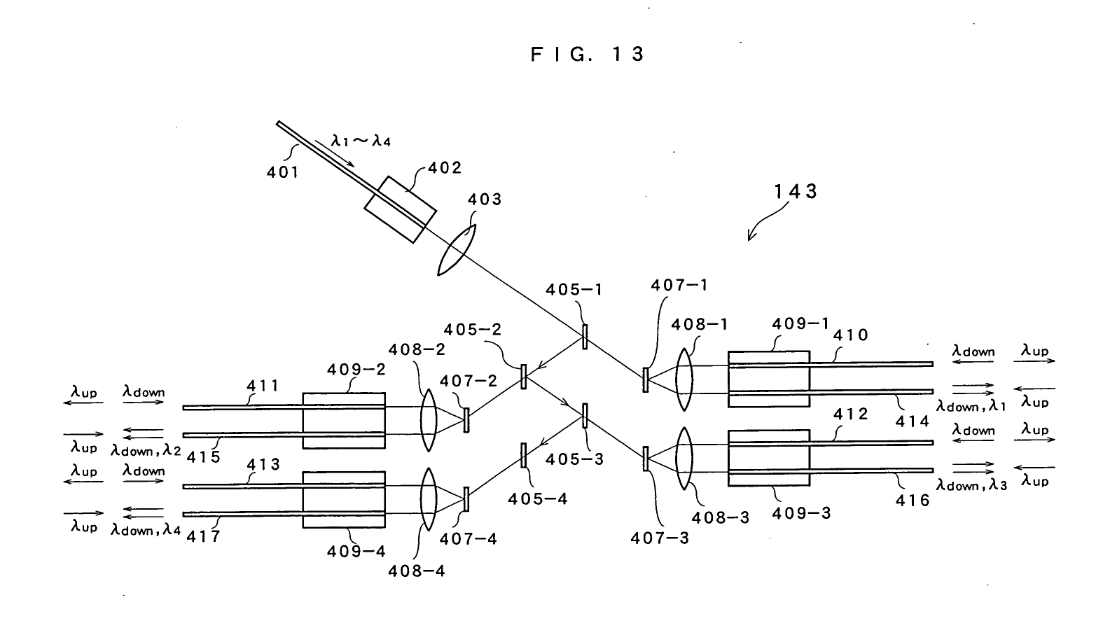

FIG. 12 shows a configuration of the composite module 142. An optical fiber 401 is held by an optical fiber holder 402. The optical fiber 401 is connected to the first optical filter part 103. Light emitted from the optical fiber 401 is made incident to a band pass filter 405-1 provided on a glass block 404 via a lens 403. The lens 403 can be configured by either one of a GRIN lens, spherical lens, and aspherical lens. Band pass filters 405-1 to 405-4 are configured by a dielectric multilayered film with a total film thickness of 23.9 μm in which Nb2O5 and SiO2 are alternately laminated for a total of 112 layers for example, on the transparent glass substrate in the infrared range. The band pass filters 405-1 to 405-4, band pass filters, pass the wavelengths λ1 to λ4, respectively, and reflects the other wavelengths. A mirror 406 is provided with parallel to an end surface of the glass block 404. The mirror 406 is composed of a metal or dielectric multilayered film. Moreover, the mirror 406 makes light reflected by each band pass filter incident again to the band pass filter in the subsequent stage on the glass block 404. Group filters 407-1 to 407-4 are then respectively attached to a position where light in the other end surface of the glass block 404 passes through each band pass filter. The group filters 407-1 to 407-4 are configured by a dielectric multilayered film with a total film thickness of 39.6 μm where Ta2O5 and SiO2 are alternately laminated for a total of 127 layers for example, on the transparent glass substrate in the infrared range. Each of the group filters 407-1 to 407-4 is a filter which passes light in a WDM-PON downlink signal bandwidth of the wavelengths λ1 to λ4, and reflects the other components. Lenses 408-1 to 408-4 and optical fiber holders 409-1 to 409-4 are provided adjacent to the group filters 407-1 to 407-4. Each optical fiber holder holds two optical fibers, respectively. Of them, each of one optical fiber 410 to optical fiber 413 is connected to the above-described power splitter part 104. Each of the other one optical fiber 414 to optical fiber 417 is connected to the ONUs 107-1 to 107-4, respectively.

A downlink signal WDM-PON having light emitted from the optical fiber 401 and converged by the collecting lens 403 is demultiplexed to optical signals of the wavelengths λ1 to λ4 respectively by the band pass filters 405-1 to 405-4 attached to the glass block 404 and the mirror 406. The demultiplexed WDM signal of each channel passes through the group filters 407-1 to 407-4 and reaches the optical fiber groups 414 to 417 through the collecting lens groups 408-1 to 408-4. The downlink signals 203 and 204 are split in the power splitter part 104, then, made incident to the optical fibers 410 to 413, and reflected by the group filters so as to be sent to the respective ONUs through the optical fibers 414 to 417 used for outputting. The uplink signal 201 from the respective ONUs is reflected by the group filters 407-1 to 407-4 through the optical fibers 414 to 417, and outputted to the power splitter part 104 through the optical fibers 410 to 413.

FIG. 13 is a diagram showing a modified example of the composite module. An identical reference numeral is used for a portion which is the same as the above-described composite module so as to omit detailed explanation. In this composite module 143, the band pass filters 405-1 to 405-4 and the group filters 407-1 to 407-4 are arranged in a position shown in the figure without using the mirror 406, and further the optical fibers are arranged on left and right sides, respectively. Therefore, a composite module can be configured with further cost reduction.

Although four channels are used as the WDM-PON signal in embodiment 5, the number of channels can be arbitrarily selected. Moreover, as the composite module, a composite module with one input and 2n input-outputs can be used. Here, n is a natural number and indicates a WDM-PON channel number.

Although each of the embodiments described above exhibits an example of applying the present invention to the G-PON optical communication system, application to various PON transmission systems such as B-PON, GE-PON and E-PON transmission systems is possible not limited to the G-PON system.

What is claimed is:

1. A WDM hybrid splitter module in an optical communication system connected between a station-side transceiver for transmitting and receiving an optical signal of a PON signal bandwidth and for transmitting an optical signal of a WDM-PON wavelength bandwidth configured with a plurality of wavelength bandwidths, and a user-end transceiver, comprising:
a first filter part connected to said station-side transceiver for separating a PON signal wavelength band from a WDM-PON signal wavelength band;
a splitter part for splitting an optical signal of a PON signal wavelength band separated by said first optical filter part into 1:n, and for coupling optical signals of an uplink PON signal wavelength band obtained from the user-end transceiver;
a demultiplexer part for splitting said WDM-PON signal wavelength band separated by said first optical filter part into each channel in accordance with a wavelength; and
a second optical filter part composed of a group of filters for coupling signals of the PON signal wavelength band split by said splitter part and either one of the WDM-PON signal wavelength bands separated by said demultiplexer part and outputting it to the user-end transceiver, and for outputting a signal of an uplink PON signal wavelength band outputted from the user-end transceiver to said splitter part.

2. The WDM hybrid splitter module according to claim 1, wherein
said first optical filter part includes filters composed of dielectric multilayered films.

3. The WDM hybrid splitter module according to claim 1, wherein
said second optical filter part includes filters composed of dielectric multilayered films.

4. The WDM hybrid splitter module according to claim 1, wherein
said demultiplexer part includes filters composed of dielectric multilayered films.

5. The WDM hybrid splitter module according to claim 1, wherein
said demultiplexer part and second optical filter part are configured by including a plurality of WDM modules integrated with one input, one output, and two input-outputs provided for each wavelength band of a WDM-PON signal.

6. The WDM hybrid splitter module according to claim 1, wherein
said demultiplexer part is composed of an array waveguide grating element.

7. The WDM hybrid splitter module according to claim 1, wherein
an integrated composite WDM module with one input and 2n input-outputs (n is a natural number) constitutes said demultiplexer part and second optical filter part.

8. The WDM hybrid splitter module according to claim 1, wherein
said WDM-PON signal wavelength band is in a bandwidth of larger than or equal to 1200 nm on a short wavelength side thereof and smaller than or equal to 1700 nm on a long wavelength side.

9. The WDM hybrid splitter module according to claim 1, wherein
said WDM hybrid splitter module is adapted to transmission systems for a G-PON (Gigabit-Passive Optical Network), B-PON (Broadband-Passive Optical Network), GE-PON (Gigabit Ethernet-Passive Optical Network), and E-PON (Ethernet-Passive Optical Network).
